(19) United States
(12) Patent Application Publication
(10) Pub. No.: US 2023/0264192 A1
(43) Pub. Date: Aug. 24, 2023

(54) MICROFLUIDIC ELECTROCHEMICAL ANALYTE DETECTORS

(71) Applicant: Massachusetts Institute of Technology, Cambridge, MA (US)

(72) Inventors: Dan Wu, Branford, CT (US); Joel Voldman, Belmont, MA (US)

(21) Appl. No.: 18/006,445

(22) PCT Filed: Jul. 16, 2021
(86) PCT No.: PCT/US2021/042003

§ 371 Date: Jan. 23, 2023

Related U.S. Application Data
(60) Provisional application No. 63/055,669, filed on Jul. 23, 2020.
(60) Provisional application No. 63/058,604, filed on Jul. 30, 2020.

(51) Int. Cl. B01L 3/00

(52) U.S. Cl. CPC B01L 3/502715; B01L 2300/0636; B01L 2300/0645; B01L 2400/0481; B01L 2400/0666; B01L 2200/0668; B01L 2300/088

(57) ABSTRACT

Microfluidic chips containing electrochemical biosensors are described. The electrochemical biosensors include a flow layer intersected by valves of a control layer, which control the fluid flow. The flow layer includes two zones, an analyte capture zone for mixing a sample with an analyte capture element, and a detection zone for detecting the analyte. Both zones include a rotary mixer for mixing, and where needed, trapping, washing, and flowing the captured analyte. The captured analyte is detected by the sensing region of the detection zone. The microfluidic chips may be integrated into devices for automated, fast, point-of-care determination of analyte concentration.

### CROSS REFERENCE TO RELATED APPLICATIONS

This application claims the benefit of and priority to U.S. Provisional Application No. 63/055,669, filed Jul. 23, 2020, and U.S. Provisional Application No. 63/058,604, filed Jul. 30, 2020, which are hereby incorporated herein by reference in their entirety

### FIELD OF THE INVENTION

The invention is generally directed to microfluidic devices with automated sample processing and analyte detection.

### BACKGROUND OF THE INVENTION

Protein testing for clinical analyses is typically done in centralized laboratories and is slow to provide results. Point-of-care devices deliver rapid results in non-laboratory settings, allowing timely analysis and in turn, reducing healthcare costs. Successful point-of-care platforms require seamless integration of chemical assays, fluid management, and signal readout.

Chemical assays for measuring protein biomarkers in blood, including immunoassays, are important in various aspects of biomedicine, clinical diagnosis and monitoring (Borrebaeck, Nature Reviews Cancer, 17:199-204, (2017)). Traditional blood tests are performed in centralized laboratories by large and expensive laboratory analyzers. Typically, turnaround times from blood draw to assay results are long, taking from hours to days, which can increase patient visits and healthcare costs, and worsen healthcare outcomes. Point-of-care (PoC) protein testing provides results quickly (in minutes) and in non-laboratory settings. Therefore, PoC devices have attracted considerable interest. While maintaining sensitivity, accuracy and specificity of laboratory tests, PoC protein testing devices should also be compact, low-cost and easy to use, and utilize small volume of samples (Song, Trends in Biotechnology, 32:132-139 (2014)). Because optical systems are expensive and challenging to miniaturize, optical protein tests performed in central laboratories cannot be directly translated into PoC settings.

There remains a need for PoC devices to measure analytes in minutes using minimal volumes of clinical samples.

Therefore, it is the object of the present invention to provide devices for rapid analyte detection in minimal volumes of clinical samples.

It is another object of the present invention to provide methods of making the devices for rapid analyte detection in minimal volumes of clinical samples.

It is yet another object of the present invention to provide methods of using the devices for rapid analyte detection in minimal volumes of clinical samples.

### SUMMARY OF THE INVENTION

Microfluidic chips and point-of-care devices for rapid detection of analyte in minute amounts of sample typically include one or more electrochemical biosensors structured to capture and amplify the signal from an analyte. The biosensors include a flow layer for fluid movement and a control layer with valves for controlling the fluid movement. The flow layer typically includes microfluidic channels in two zones: an analyte capture zone containing a microfluidic rotary mixer, and a detection zone containing a microfluidic rotary mixer with a sensing region. The sensing region typically includes a working electrode coated with a capture moiety.

The biosensor typically includes an inlet zone for receiving a sample and an analyte capture element. The biosensor also includes a collection zone for collecting the flow through and analyzed samples.

The valves of the control layer typically include a flexible membrane at intersections with the flow layer. The valves may form a rotary pump with at least three valves configured for sequential operability and intersecting the analyte capture zone and/or the detection zone. The rotary pump may be a peristaltic pump. The valves of the control layer may be below the flow layer and the valves are pushed up into the flow layer.

The microfluidic channels may have a substantially circular cross-section, or a substantially angular cross-section, such as a square, a rectangular, or a triangular cross-section, wherein height to width ratio of the microfluidic channels is between about 1:2 and about 1:15. The microfluidic channels may have a diameter or a height between about 10 μm and 1000 μm, and length between about 5 and 100 mm.

The detection zone may include a trap region containing a magnet, a gel, or other capture substance for releasably trapping the analyte-analyte capture element complex.

The microfluidic chips may have between two and ten electrochemical biosensors.

Also described are devices containing microfluidic chips and methods of making and using the microfluidic chips. Typically, the methods include stereolithography, soft lithography, laser machining, micromachining, curing, bonding, three-dimensional printing, molding, micromolding, thermal setting, metal deposition, and/or coating.

A method of detecting an analyte or measuring the analyte concentration in a sample is also described. The method includes loading sample and an analyte capture element into the flow layer of the microfluidic chip. The sample volume may be as little as between about 0.5 μL and 500 μL, such as between about 1 μL and 10 μL, although larger volumes between about 10 μL and 500 μL may also utilized. By using capture, trap, and signal amplification with the analyte capture element and capture moiety, the method provides highly sensitive detection (between about 10⁻⁹ and 10⁻¹² g/ml) of an analyte in minute amounts of sample within minutes.

The signal amplification is achieved by the use of an analyte capture element or capture moiety containing a reporter molecule. The reporter molecule typically converts a chemical substrate to an electrical signal for detecting by the sensing region of the electrochemical biosensor.

### BRIEF DESCRIPTION OF THE DRAWINGS

FIG. 1 is a diagram showing the schematic system-level overview of an all-electrical PoC system with the microfluidic control module on the left and amperometry and bead-based electronic ELISA biosensor on the right. SRCLK: shift register clock signal; RCLK: register clock signal; WE: working electrode; SER: serial.

FIG. 2A is a flow diagram showing the steps in the bead-based electronic ELISA. FIG. 2B is a schematic layout of the biosensor. The area in the dashed box is enlarged in FIG. 2C. FIG. 2C is a diagram showing the workflow of an automated bead-based electronic ELISA. FIGS. 2D and 2E are a diagrams of microfluidic valves operation.

FIG. 3A is a diagram showing microfluidic peristaltic pumping using three valves, and shows a microfluidic peristaltic pump using three valves (Pi, Pj, and Pk). FIG. 3B is a diagram showing the control sequences for the valves in FIG. 3A. FIG. 3C is a graph showing relationship between flow rate (flow rate, μL/min) and duration of controlling sequence over Ts (ms).

FIGS. 4A-4D are diagrams and corresponding results for mixing an exemplary protein such as free bovine serum albumin (BSA) using a rotary pump (FIGS. 4A and FIG. 4C) or with beads (FIGS. 4C and 4D). FIG. 4B is a graph showing change in Intensity over time (sec). FIG. 4D is a graph showing a change in Bead Number over time (sec).

FIG. 5 is a graph showing a calibration curve obtained from the integrated and automated electrical sensing system. The samples were made by spiking human IL-6 into 4-fold diluted human plasma to different concentrations. The error bars represent measurement from two separate sensors. The total assay time was 30 minutes.

### DETAILED DESCRIPTION OF THE INVENTION

### I. Definitions

As used herein, the term “microfluidic” refers to devices with dimensions of fluidic pathway elements for manipulating and controlling fluids, usually in the range of microliters (10⁻⁶) to picoliters (10⁻¹²), in networks of channels with dimensions from tens to hundreds of micrometers.

As used herein, the term “biosensor” refers to a microflidic sensor configured to receive, capture, and detect the presence and/or the concentration of an analyte in a sample.

As used herein, the term “flow layer” refers to a layer of microfluidic channels receiving assay fluids, such as a sample and an analyte capture element, buffers, etc., for detecting the analyte concentration.

As used herein, the term “control layer” refers to a layer of microfluidic channel and one or more valves containing fluid, air, or gas, and connected to controls for operating the one or more valves.

As used herein, the term “rotary mixer” refers to a looped microfluidic channel. The microfluidic channels may be looped in a form a circle, oval, semicircle, or any loop-forming geometry. The rotary mixer may be intersected with at least one, at least two, or at least three valves.

As used herein, the term “analyte capture zone” refers to a region on the biosensor that mixes a sample with an analyte capture element to form a captured analyte, i.e., an analyte-analyte capture element complex.

As used herein, the term “detection zone” refers to a region on the biosensor that traps, washes, and detects the analyte.

As used herein, the term “sensing region” refers to a region in the detection zone containing at least one working electrode and capable of detecting changes in the electric current.

As used herein, the term “rotary pump” refers to a group of valves operating in a specific sequence to achieve a rotary motion of the content in a rotary mixer.

As used herein, the term “substantially” refers to comparative measure similar to almost, about, or essentially.

As used herein, the term “analyte” refers to any small molecule or a macromolecule, such as a protein or a nucleic acid, of interest analyzed by the biosensor.

As used herein, the term “analyte capture element” refers to a macromolecule, such as a protein or a nucleic acid, conjugated to a reporter moiety. The analyte capture element may be a nucleic acid sequence having a portion that is complementary to the analyte, an antibody, an antigen-binding fragment of an antibody, a receptor, a ligand-binding fragment of a receptor, an affinity molecule, or a modified substrate. The analyte capture element may be conjugated to a trap element.

As used herein, the term “reporter moiety” refers to a moiety converting a chemical input to an electric signal that alters the electric current at the sensing region. Exemplary reporter moieties include enzymes catalyzing redox reactions, co-factors, receptors, organic and inorganic redox catalysts, and the like.

As used herein, the term “trap element” refers to a moiety configured to interact with and be trapped by the trap region of the biosensor, and includes any of magnetic beads, strings, nanoparticles, nanotubes, nanowires, polymers, proteins, nucleic acids, and any element that is trapped by the trap region.

As used herein, the term “trap region” refers to a region in the detection zone configured to trap the analyte-analyte capture element complex. The trap may be a physical trap, such as a magnetic field, a porous gel, a phase-change polymer, a region coated with high avidity molecule, or a chemical trap, such as a region coated with a releasable linker. The trap region typically traps the analyte-analyte capture element complex.

As used herein, the term “capture moiety” or “complex capture moiety” refers to macromolecule, such as a protein or a nucleic acid, coated on the one or more electrodes of the sensing region.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%.

### II. Chip and Device

The microfluidic chips contain one or more electrochemical biosensors detecting small molecules and macromolecules in a sample. The microfluidic chips may be integrated into a device for point-of-care applications to detect a concentration of the small molecules or the macromolecules. Typically, the biosensors are affinity-type or complementarity-type biosensors and require an analyte capture element.

An affinity biosensor or complementarity-type sensor operates as a function of permanent or semi-permanent binding between the biorecognition element and the analyte. These biosensors include immunosensors (antibody-antigen binding), nucleic acid biosensors (probe and complementary nucleic acid target binding), and aptamer biosensors (ligand and synthetic oligonucleotide receptor binding). Also included are catalytic biosensors, where the interaction between the analyte and the biorecognition element is not permanent, and involves a chemical reaction that forms an easily detected product. This class of biosensors includes enzymatic biosensors, cell-based biosensors, and biosensors relying on catalytically active polynucleotides (DNAzymes). Catalytic systems are particularly useful for trace analysis because of the inherent amplification; i.e., the presence of a single analyte molecule can result in a large number of products to be detected.

### A. Microfluidic Chip

The microfluidic chips include one or more electrochemical biosensors for detecting an analyte. The microfluidic chips may include between one and ten electrochemical biosensors, each detecting the same or different analytes from the same or different samples.

Generally, the microfluidic chips have microchannels with a substantially circular cross-section or a substantially angular cross-section, such as a square, a rectangular, or a triangular cross-section. The cross-section may have sharp or curved angles so that the square, the rectangular, or the triangular cross-section includes sharp or curved angles. Typically, the microchannels with angular cross-section have a height to width ratio between about 1:2 and about 1:15, between about 1:2 and about 1:12, between about 1:2 and about 1:10, between about 1:2 and about 1:8, or between about 1:2 and about 1:5.

Typically, the microchannels with a substantially circular cross-section have a diameter between about 10 μm and about 1000 μm, such as between about 10 μm and about 900 μm, between about 10 μm and about 750 μm, between about 10 μm and about 500 μm, or between about 10 μm and about 250 μm. Typically, the microchannels with a substantially angular cross-section have a height between about 10 μm and about 250 μm, between about 10 μm and about 200 μm, between about 10 μm and about 150 μm, or between about 10 μm and about 100 μm.

The microfluidic chips operate at a flow rate between about 0.5 μL/min and 50 μL/min, such as about 1 μL/min and 40 μ/min, about 1 μL/min and 20 μL/min, about 1 μL/min and 10 μL/min, about 1 μL/min and 7.5 μL/min, or about 1 μL/min and 5 μL/min.

Typically, the electrochemical biosensors of the microfluidic chips operate with sample volumes between about 0.5 μL and about 500 μL, between about 1 μL and about 500 μL, between about 1 μL, and about 400 μL, between about 10 μL and about 300 μL, or between about 10 μL and about 200 μL.

### 1. Electrochemical Biosensor

Typically, the electrochemical biosensor includes two layers, a flow layer containing analyte intake and processing zones, and a control layer containing valves and optionally pumps. The valves of the control layer intersect the flow layer at specific zones to control the sample loading, mixing of the sample with an analyte capture element, trapping, washing, and capturing. The different intake and processing zones of the flow layer are connected with one or more fluidic channels, which provide the fluidic connections between the zones.

### a. Flow Layer

The flow layer typically includes an inlet zone fluidically connected with an analyte capture zone. The analyte capture zone is fluidically connected with a detection zone. The detection zone may be, in turn, fluidically connected with a collection zone.

The flow layer achieves intake, mixing, trapping, washing and capturing of the analyte complexed with an analyte capture element. The flow layer achieves this with the function of a rotary mixer in the analyte capture zone and the function of a rotary mixer, a trapping region, and a sensing region in the detection zone.

### i. Inlet Zone

The inlet zone of the electrochemical biosensor is typically formed of one or more microfluidic channels intersected by one or more valves of the control layer. The valves, when open, permit intake of fluid, such as samples and solutions containing analyte capture elements. Closure of the valves at the one or more microfluidic channels allows the fluid intake to flow into the analyte capture zone.

### ii. Analyte Capture Zone

The analyte capture zone is typically a looped microfluidic channel fluidically connected to the inlet zone at one portion of the analyte capture zone and to the detection zone at another portion of the analyte capture zone. The looped microfluidic channel may be in a shape of a circle, oval, semicircle, or any loop-forming geometry. The looped microfluidic channel is typically intersected with at least one, at least two, or at least three valves, which form a rotary mixer.

### Rotary Mixer

The analyte capture zone includes a rotary mixer formed of the looped microfluidic channel and its intersecting valves of the analyte capture zone. The operability of the valves ensures mixing of two or more fluids in the loop. The fluids may be the sample and the analyte capture element. The fluids may be completely mixed within a time period between about 30 seconds and 200 seconds, such as between about 30 sec and 120 sec, or between about 30 sec and 100 sec.

After mixing, the fluids are flown into the detection zone.

### iii. Detection Zone

The detection zone is typically a looped microfluidic channel fluidically connected to the analyte capture zone at one portion of the detection zone and to a collection zone at another portion of the detection zone. The looped microfluidic channel may be in a shape of a circle, oval, semicircle, or any loop-forming geometry. The looped microfluidic channel is typically intersected with at least one, at least two, or at least three valves, which form a rotary mixer.

### Rotary Mixer

The detection zone includes a rotary mixer formed of the looped microfluidic channel and its intersecting valves of the analyte capture zone. The operability of the valves ensures mixing of two or more fluids in the loop. The fluids are moved by the mixer to a trap region, if present, and/or to the sensing region. The valves operate to direct the fluid to the desired region. A valve in-between the two regions isolates the two regions from each other.

Some samples, such as environmental or food industry runoff, may be sufficiently dilute and not require washing to detect the analyte bound to the analyte capture element. Other samples, such as blood, plasma, saliva, may require washing of the analyte bound to the analyte capture element to remove unbound molecules.

If washing of the analyte-analyte capture element complex is needed, the fluids are typically moved to the trap region.

### Trap Region

The trap region is a region on a rotary mixer of the detection zone to receive and reversibly hold on to analyte-analyte capture element complex. The trap region may be a physical trap, such as a region with a magnetic field, a porous gel, a phase-change polymer, a region coated with high avidity molecule, or a chemical trap, such as a region coated with a releasable linker. The trap region typically reversibly traps the analyte-analyte capture element complex.

For example, a magnet in the trap region may be activated to trap an analyte-analyte capture element complex. After washing, the deactivation of the magnet may release the beads. Similarly, a porous gel with a pore size sufficient to trap the analyte-analyte capture element complex may be used, and after washing, the trapped complex may be released with a sufficient high fluid flow pressure.

After washing, if needed, the analyte-analyte capture element complex is flown over the sensing region.

### Sensing Region

The sensing region is a region in the detection zone containing at least one working electrode and capable of detecting changes in the electric current. Typically, the one or more of the electrodes of the sensing region are coated with a capture moiety.

Typically, the sensing region uses the redox activity of a solute in solution, either the analyte itself, an electroactive label (reporter moiety) attached to the analyte capture element, or a catalytically generated electroactive reporter. The electrons generated in the redox process are detected as current, which is related to the number of redox species involved in the process. In some instances, an electron transfer mediator is used to shuttle electrons from the electroactive species to the electrode surface (e.g., from the redox center of an enzyme to the electrode).

The electrochemical biosensors transduce signals by means of amperometry, voltammetry, or electrochemical impedance spectroscopy (EIS). Amperometric and voltammetric sensors are often used in catalytic mode; for example, in amperometric sensors, the working electrode (WE) is coated with a layer of a capture moiety linked to a reporter moiety, such as an enzyme. When the analyte encounters the reporter moiety, a product is formed, which may oxidize at the WE to generate a current that is proportional to the amount of analyte.

EIS is typically used for affinity biosensing, in which a capture moiety, such as antibodies, receptors, or nucleic acids, is attached to the WE surface and binds the captured analyte. The charge transfer resistance experienced by an electroactive reporter as it diffuses through the film of capture moieties is a measure of the amount of bound analyte and the charge on the surface (Rackus et al., Chem. Soc. Rev., 44:5320 (2015)).

The sensing region typically contains at least one working electrode WE), a reference electrode (RE) and a counter electrode (CE). The one or more of the working electrode, a reference electrode and a counter electrode may be a planar electrode, a three-dimensional electrode, a porous electrode, a disk electrode, a spherical electrode, a plate electrode, a hemispherical electrode, a microelectrode, and a nanoelectrode, or an array thereof), an ion selective electrode (e.g., including a porous material and one or more ionophores), an optical sensor, an array of any of these, and their combinations. piezoelectric sensors (e.g., including one or more quartz crystals or quartz crystal microbalance), electrochemical sensors (e.g., one or more of carbon nanotubes, electrodes, field-effect transistors, as well as any selected from the group consisting of an ion selective electrode, an ion sensitive field effect transistor (e.g., a n-p-n type sensor), a light addressable potentiometric sensor, an amperometric sensor (e.g., having a two-electrode configuration (including reference and working electrodes) or a three-electrode configuration (including reference, working, and auxiliary electrodes)), and/or an impedimetric sensor.

The sensing region typically includes a working electrode having an exposed working area. The working electrode includes any useful conductive material (e.g., gold, indium tin oxide, titanium, and/or carbon). Optionally, the working area is surface modified, e.g., with a linking agent and/or a capture moiety.

The electrode can have any useful configuration, such as, e.g., a disk electrode, a spherical electrode, a plate electrode, a hemispherical electrode, a microelectrode, or a nanoelectrode; and can be formed from any useful material, such as gold, indium tin oxide, carbon, titanium, platinum, etc.

Exemplary electrodes include a planar electrode, a three-dimensional electrode, a porous electrode, a post electrode, a milli- or a micro- electrode (e.g., having a dimension in the range of between about 1 μm and about 10 mm, such as a radius, width, or length between about 1 μm and about 10 mm, or between about 1 μm and 1000 μm), a nanoelectrode (e.g., having a dimension on the range of 1 nm to 100 nm, such as a radius, width, or length between about 1 nm and 100 nm), as well as arrays thereof. For instance, a three-dimensional (3D) electrode can be a three-dimensional structure having dimensions defined by interferometric lithography and/or photolithography.

In other embodiments, the electrode is a nanoelectrode such as a nanodisc, a nanoneedle, a nanoband, a nanoelectrode ensemble, a nanoelectrode array, a nanotube (e.g., a carbon nanotube), a nanopore, as well as arrays thereof. Any of these electrodes can be further functionalized with a conductive material, such as a conductive polymer, such as poly(bithiophene), polyaniline, or poly(pyrrole), for example, dodecylbenzenesulfonate-doped polypyrrole; a metal, such as metal nanoparticles, for example, gold, silver, platinum, and/or palladium nanoparticles, metal microparticles, a metal film (e.g., palladium or platinum), a nanotube; etc.

The electrodes can optionally be surface-modified with one or more capture moieties (e.g., one or more antibodies, one or more receptors, one or more nucleic acids).

### Electrode Modification

The capture moiety may be coated on the surface of the electrodes. The capture moiety may be attached to the electrodes via one or more linking agents. Exemplary linking agents include compounds including one or more first functional groups, a linker, and one or more second functional groups.

Generally, the first functional group allows for linking between a surface and the linker, and the second functional group allows for linking between the linker and the capture moiety.

Exemplary linkers include any useful linker, such as polyethylene glycol, an alkane, and/or a carbocyclic ring (e.g., an aromatic ring, such as a phenyl group). In particular embodiments, the linking agent is a diazonium compound, where the first functional group is a diazo group (—N₂), the linker is an aryl group (e.g., a mono-, bicyclic, or multicyclic carbocyclic ring system having one or two aromatic rings and is exemplified by phenyl, naphthyl, xylyl, 1,2-dihydronaphthyl, 1,2,3,4-tetrahydronaphthyl, fluorenyl, indanyl, and indenyl), and the second functional group is a reactive group for attaching a capture moiety (e.g., where the second functional group is halo, carboxyl, amino, sulfo, etc.). Such diazonium compounds can be used to graft an agent onto a surface (e.g., an electrode having a silicon, iron, cobalt, nickel, platinum, palladium, zinc, copper, or gold surface). In some embodiments, the linking agent is a 4-carboxybenzenediazonium salt, which is reacted with a capture moiety by 1-ethyl-3[3-dimethylaminopropyl] carbodiimide hydrochloride (EDC)IN-hydroxysuccinimide (NHS) crosslinking, to produce a diazonium-capture moiety complex. This resultant complex is deposited or grafted onto a surface (e.g., an electrode surface).

Other exemplary linking agents include pairs of linking agents that allow for binding between two different components. For instance, biotin and streptavidin react with each other to form a non-covalent bond, and this pair can be used to bind particular components.

### Capture Moiety

Typically, the sensing region includes a capture moiety that binds to the analyte-analyte capture element complex. The capture moiety is generally a macromolecule, such as a protein or a nucleic acid, coated on the one or more electrodes of the sensing region. The capture moiety has an affinity to, or is complementary to, a portion of the analyte. When the analyte-analyte capture element complex is flown over the sensing region, the capture moiety binds to the complex.

### b. Control Layer

The control layer of the microfluidic chip is a layer of microfluidic channels and one or more microfluidic valves containing fluid, air, or gas, connected to controls for operating the one or more microfluidic valves. The control layer may be positioned above or below the flow layer. The one or more microfluidic valves of the control layer intersect any one of microfluidic channels of the flow layer fluidically connecting the inlet zone to the analyte capture zone, the analyte capture zone to the detection zone, and the detection zone to the collection zone. The one or more microfluidic valves may intersect any one of microfluidic channels of the rotary mixers.

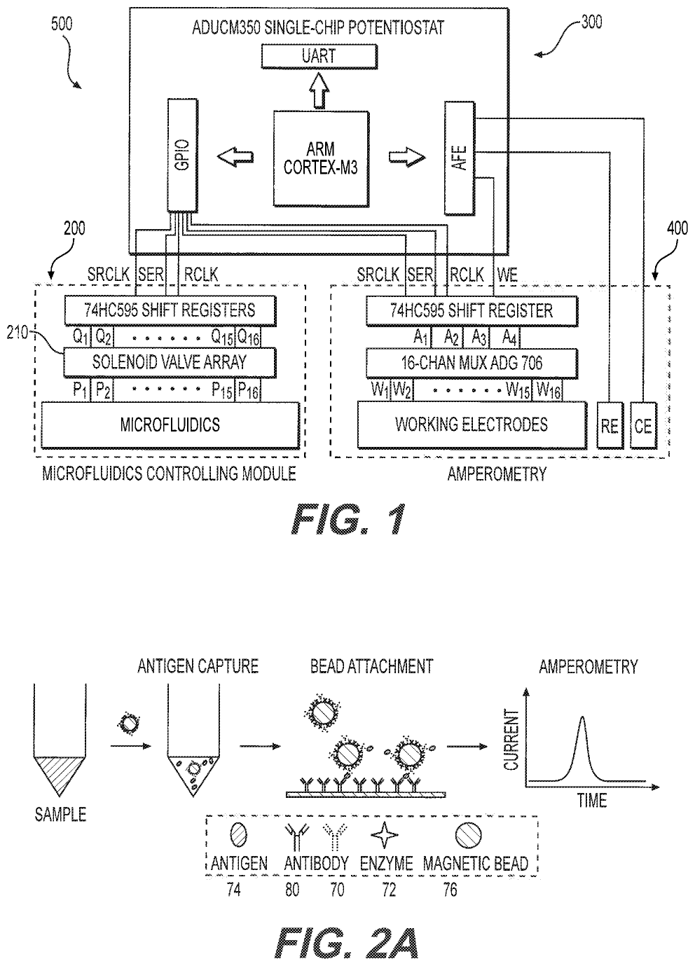

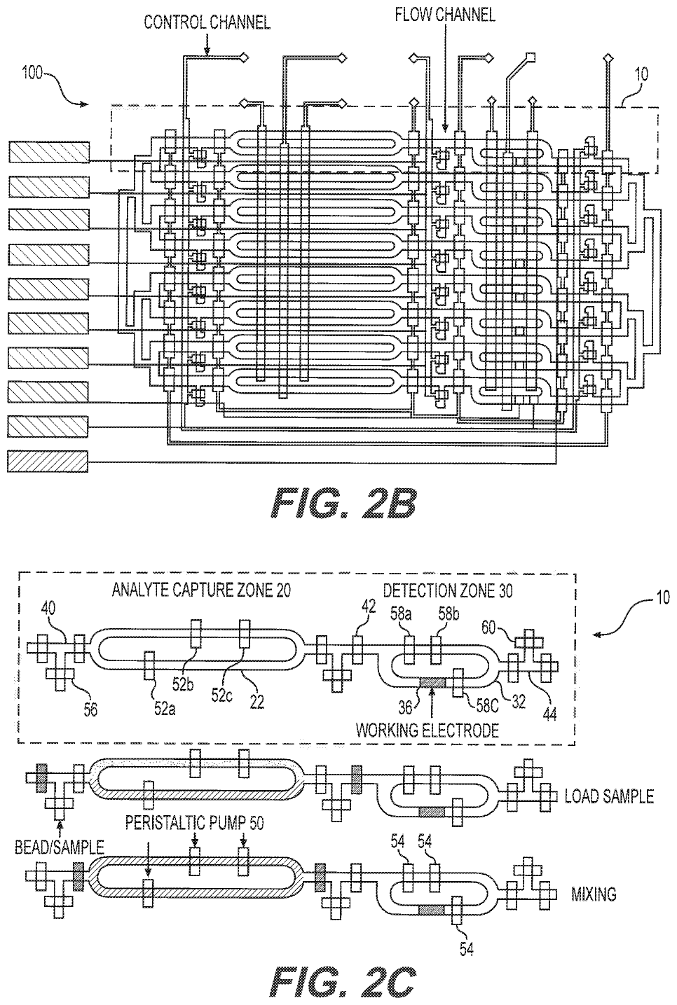

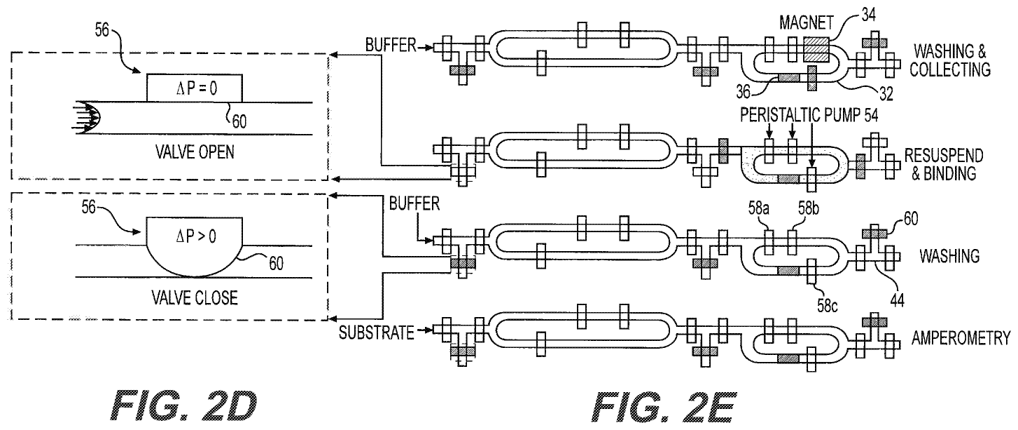

At the point of intersection of the flow layer with the control layer, the microfluidic valves of the control layer include a flexible membrane that extends into the flow layer when pressurized (FIG. 2D).

When positioned above the flow layer, the valves close and block the fluid flow by extending down into the flow layer (FIG. 2D). When positioned below the flow layer, the valves close and block the fluid flow by extending up into the flow layer.

Typically, the valves operate at pressures between about 5 psi and about 50 psi, such as between about 10 psi and about 45 psi, between about 10 psi and about 40 psi, or about 30 psi. Typically, the valves operated at 40 psi demonstrate over 90% valve closure when the membrane is a thin PDMS membrane, polyurethane film, or any other flexible thin film. Typically, the thickness of the membrane is between about 1 μm and 100 μm.

The valves may stop fluid flow in the flow layer at valve closure between about 50% and 95%. The valve closure between about 50% and 95% is typically sufficient for the operability of the electrochemical biosensors. For example, the biosensor may be operable at valve closure between about 50% and 95%, between about 60% and 90%, between about 70% and 90%, or between about 80% and 90%.

### 2. Exemplary Electrochemical Biosensor

FIGS. 2A-2E are diagrams of an exemplary electrochemical biosensor 10 with its elements.

The electrochemical biosensor typically includes an analyte capture zone 20 fluidically connected with a detection zone 30. The analyte capture zone includes a rotary mixer 22 controlled by the rotary pump 50 formed of three valves (52a-52c). The sample and the analyte capture element are loaded at the inlet zone formed of microfluidic channels 40 and controlled by valves 56. The sample is mixed with the analyte capture element in the rotary mixer 22 by the operability of the rotary pump 50.

FIG. 2A is a diagram of an exemplary analyte capture element 70 (an antibody in this example), attached to a reporter moiety 72 (enzyme in this example) and a trap element 76 (magnetic bead in this example).

FIG. 2C shows the captured analyte flows from the analyte capture zone 20 via fluidic channels 42 into the detection zone 30. FIG. 2E shows the detection zone 30 includes the rotary mixer 32, the trap region 34, and the sensing region 36. The rotary mixer 32 is controlled by the rotary pump 54 formed of three valves 58a-58c. The detection zone may be fluidically connected to a collection zone formed of microfluidic channels 44 intersected by valves 60. The trap region 34 in this example is a magnet, but it may be any physical or chemical entity capable of reversibly trapping the analyte-analyte capture element complex, such as porous gel, a phase-change polymer, a coating with a high avidity molecule, or a coating with a releasable linker.

The trapping of the analyte-analyte capture element complex in the trap region 34 allows for washing and removing the excess molecules from the sample. The trapped analyte-analyte capture element complex is then released to bind the capture moiety 80 (FIG. 2A, an antibody in this example) on the sensing region. In this example, the reporter moiety 72 of the complex is an enzyme, a horseradish peroxidase. During measurement, a substrate (mixture of 3,3′,5,5′-Tetramethylbenzidine and hydrogen peroxide) is introduced to generate current by the enzyme over the sensing region.

### B. Device

The device includes the microfluidic chip connected to a microfluidics controlling module, a potentiostat, an amperometry module, electrically connected to a counter electrode, a reference electrode, and at least one working electrode of the sensing region of the biosensor. The microfluidic controlling module is connected with the control layer of the biosensor. The device may further include a power source and a data-processing circuit powered by the power source. The device may include a data output port for the data-processing circuit. The device may include a telemetry unit configured to receive processed data from the data-processing circuit and to transmit the data wirelessly.

The device may include a display means, such as a screen, a monitor, or a window for displaying the results of the biosensor. The device may display data, such as data from the electrodes. These can include any useful information, such as electromotive force (EMF), potentiometric, amperometric, impedance, and/or voltammetric measurements. The device may also display processed data, where the data from the electrodes is converted to analyte concentration and displayed.

The combination of the modules in one device provides a point-of-care (PoC) device for fast and accurate automated analyte measurement.

An exemplary device is presented in FIGS. 1A and 1B. The device 500 includes a microfluidic chip 100 with one or more electrochemical biosensors connected to the microfluidics controlling module 200, potentiostat 300, and amperometry 400. The microfluidics controlling module 200 includes a solenoid valve array 210 for controlling the valves of the control layer.

Because optical systems are expensive and challenging to miniaturize, optical protein tests performed in central laboratories cannot be directly translated into PoC settings.

Electrically mediated systems have a natural advantage for these metrics as they can reduce system complexity and leverage microelectronics' size and cost scaling. For sensing, electrochemical biosensors, which detect biological events through electrical measurements (e.g., amperometry), are useful and some are commercially available (e.g., glucose sensing).

Besides assay chemistry and signal readout, equally important to system design is fluid control functionality, as most immunoassays involve fluid operations such as diluting, washing and mixing. Microfluidics is ideally suitable for automated handling of small biofluid volumes (about μL range). Importantly, multilayer soft lithographic systems can implement fluid handling steps using electronic interfaces.

The device is an automated electronically controlled PoC system. While lab-on-chip ELISAs have been developed by taking advantage of microfluidics, most of those systems either rely on optical readout (which is expensive and challenging to miniaturize) (Lee et al, Lab on a Chip, 15:478-485 (2015)) or need manual interventions (Sun et al., Lab on a Chip, 10:2093-2100 (2010)). The device is an automated, all-electrical and thus can be readily miniaturized and scaled up. Using this compact electronic system, a 30-mintue PoC detection of human interleukin-6 (IL-6) is demonstrated in the Examples, which has multiple indications in clinical diagnosis.

### III. Methods of Making the Microfluidic Chip and Device

The microfluidic chip is typically formed of polydimethylsiloxane (PDMS), polysulfone (PSF), and other materials. PDMS is a versatile elastomer that is easy to mold, and PSF is a rigid, amber colored, machinable thermoplastic. Other suitable materials include biologically stable thermosetting polymers, including polyethylene, polymethylmethacrylate, polyurethane, polysulfone, polyetherimide, polyimide, ultra-high molecular weight polyethylene (UHMWPE), cross-linked UHMWPE and members of the polyaryletherketone (PAEK) family, including polyetheretherketone (PEEK), carbon-reinforced PEEK, and polyetherketoneketone (PEKK). Preferred thermosetting polymers include, but are not limited to, polyetherketoneketone (PEKK) and polyetheretherketone (PEEK).

Methods of making the chips include stereolithography, soft lithography, laser machining, micromachining, curing, bonding, three-dimensional printing, molding, micromolding, metal deposition, and coating.

The electrochemical biosensors at the sensing region may include an electrochemical cell featuring three electrodes, i.e. circular working electrode (suitable dimeter about 500 μm, about 400 μm, about 300 μm, about 200 μm, or about 100 μm), a square counter electrode (suitable dimensions between about 100 μm and 800 μm by between about 100 μm and 800 μm) and a reference electrode (suitable dimensions between about 100 μm and 600 μm by between about 100 μm and 800 μm). The electrodes may be fabricated by depositing 15 nm titanium onto a Pyrex wafer (Bullen Ultrasonics) followed by 200 nm gold. Ag/AgCl ink may be applied onto the reference electrodes and heated at 120° C. for about two minutes to form Ag/AgCl reference electrodes.

The device is typically formed by combining and connecting the microfluidic chip with commercially available instrumentations for the microfluidics controlling module, a potentiostat, and amperometry. For example, ADUCM350 evaluation kit (Eval-ADuCM350EB1Z) from Analog Devices, Inc. ADUCM350 is a single-chip potentiostat that features an ARM® Cortex M3 processor and an electrochemical measurement analog front-end. Since the current for the electronic measurements may be smaller than 230 nA, a 5 Mohm resistor (1% tolerance) and a 47 pF capacitor (5% tolerance) may be placed across the transimpedance amplifier feedback path.

An exemplary performing amperometry measurement and controlling microfluidic fluid management is the single-chip potentiostat (ADUCM350 from Analog Devices, Inc) is the heart of this all-electrical system (FIG. 1). Interfaced with two 8-bit shift registers, the microcontroller can control up to 16 solenoid valves. The use of shift registers allows for the operation of multiple solenoids simultaneously, which enables complex fluid management. The solenoids valves are connected to microfluidic valves and can be programmed to achieve fluid management such as peristaltic pumping, mixing and valving.

Through a 16-channel single-pole-single-throw analog multiplexer, the microcontroller can alternate amperometry measurement across up to 16 electrochemical cells. The biosensor may be connected to the amperometry circuitry through a card edge connector.

### IV. Methods of Using the Microfluidic Chip and Device

### A. Microfluidic Chip Use

The microfluidic chip and/or device can be used in a variety of methods. For instance, point-of-care (POC) diagnostics allow for portable and/or disposable systems, and the device herein can be adapted for POC use.

The microfluidic chip and/or device may be used to determine the concentration of any useful marker or targets. Typically, the markers and targets are detectable by ELISA, including sandwich ELISA, or nucleic acid hybridization techniques. The microfluidic chip and/or device may detect one or more physiologically relevant markers, such as small molecules like as epinephrine, metabolities and cortisol as well as therapeutic, prophylactic and diagnostic agents, and proteins such as neurotransmitters, cytokines (e.g., TNF-α, interleukin (IL)-6, IL-12, or IL-1β, cancer biomarkers, hormones such as human chorionic gonadotrophin (hCG) or a peptide hormone, inflammatory markers (e.g., c-reactive protein, CRP), disease-state markers, viral markers (e.g., markers for human immunodeficiency virus, hepatitis, influenza, Ebolavirus, coronavirus, including SARS-Cov-2 and COVID-19, or chlamydia), and nucleic acids (e.g., DNA and/or RNA).

Typically, the analyte capture element is a receptor, a receptor fragment having a ligand-binding region, an antibody, an antibody fragment having an antigen-biding region, a complementary nucleic acid sequence, or a reporter molecule undergoing a change in its redox state. Exemplary antibodies, receptors, nucleic acids and reporter molecules are known in the art.

For example, antibodies binding human cytokines are commercially available, and may be selected for binding antigens as well as denatured or folded antigens, from suppliers such as CELL SIGNALING TECHNOLOGY® (Cell Signaling Technology, Inc., Danvers, Mass.), ABCAM® (Abcam Plc Company, Cambridge, UK), RAYBIO® (RayBiotech, Inc, Norcross, Ga.), GENETEX® (GeneTex, Inc., Irvine, Calif.), BIOLEGEND® (BioLegend, Inc., San Diego, Calif.), INVITROGEN® (Invitrogen Corporation, Carlsbad, Calif.), BIO-RAD® (Bio-Rad Laboratories, Inc., Hercules, Calif.), MILTENYI BIOTEC® (Miltenyi Biotec GmbH., Bergisch Gladbach, Germany), and others.

Complementary nucleic acids can be made to order at commercially available companies, including FISHER SCIENTIFIC® (Pittsburgh, Pa.), TRILINK® Biotechnologies (San Diego, Calif.), GENEWIZ® (South Plainfield, N.J.), and GENSCRIPT® (Piscataway, N.J.).

### 1. Biorecognition

Enzyme-based biosensors are catalytic sensors in which the bioreceptors include enzyme molecules in solution or tethered to a surface. Enzyme-based biosensors are typically implemented in direct or indirect format. In the direct format, the analyte promotes the activity of an enzyme (either acting as a co-factor for the enzyme or in concert with an affinity binding event to localize the enzyme near the analyte), which catalyzes the formation of a measurable product (i.e., analyte concentration is proportional to signal). In the indirect format, the analyte inhibits the activity of the enzyme, resulting in reduced rates of formation of a measurable product (i.e., analyte concentration is inversely proportional to signal).

### a. Immunosensors

Immunosensors are affinity-based biosensors that rely on the binding of an antibody to its specific antigen or a nucleic acid to its complementary sequence. Immunosensors are implemented in a variety of schemes, including (a) direct format, featuring binding of an unlabeled antigen to an unlabeled antibody (requiring label-free transduction), (b) competitive format, featuring competition for binding of an unlabeled (target) antigen and a labeled (exogenous) antigen to an antibody, (c) “sandwich” format featuring an antigen with two epitopes (i.e., antibody-recognition sites) that binds to an immobilized primary antibody and also to a labeled- or enzyme-modified secondary antibody, and (d) inhibition format featuring competition between an analyte and a primary antibody for binding to a labeled (or enzyme-modified) secondary antibody.

### b. Nucleic Acid Bases Sensors

Nucleic acid-based biosensors are affinity sensors that exploit the sequence-specific Watson-Crick base pairing between nucleic acids and their complements. The most common form of nucleic acid sensors are formed from a single-stranded DNA (ss-DNA) probe that is immobilized onto the surface of a transducer. Upon recognition of its complementary ss-DNA or RNA analyte (or target) by hybridization, transduction is facilitated by electrochemical, or mass-sensitive techniques.

There are a number of variations on the simple DNA-probe-DNA target theme. One variation uses peptide nucleic acid (PNA) probes, in which the negatively charged sugar-phosphate backbone of DNA is replaced by a neutral pseudopeptide chain. PNA probes have higher binding affinities (relative to their analogous ss-DNA probes) for ss-DNA targets, and the reduced charges on these probes confer advantages for some forms of electroanalysis.

Another variation is the sandwich assay, in which an immobilized probe binds a region of an analyte, and a second, labeled probe binds a different region of the analyte.

A third variation known as a “molecular beacon” features probe-sequences that self-bind to form stem-and-loop or hairpin structures. Complementary targets compete for binding with such structures (requiring the probe to undergo a change in conformation) which can enable very sensitive detection of small numbers of targets.

The most useful nucleic acid biosensors allow for differentiation between the binding of a target that is perfectly complementary to the probe and a target that has a one base-pair mismatch with the probe. This level of selectivity is required to identify single nucleotide polymorphisms (SNPs); there is great interest in using SNP detection to identify patients with genetic diseases.

### c. Aptamer Based Sensors

Aptamer-based biosensors feature an alternative form of affinity biorecognition relying on synthetic oligonucleotide (single-stranded DNA or RNA molecules) probes; in contrast to conventional nucleic acid sensors (which bind only their complements), aptamers can be designed to bind any type of target. Aptamers are prepared by a combinatorial approach called systematic evolution of ligands by exponential enrichment (SELEX).

Aptamers modified with electroactive indicators, fluorescent tags, nanoparticles and enzymes have been used for amplified detection of a wide range of analytes, including amino acids, antibiotics, co-factors, drugs, metal ions, nucleic acids, and organic dyes.

### 2. Samples

The microfluidic chip and/or device can be used to test any useful test sample, such as blood (e.g., whole blood), plasma, serum, trans dermal fluid, interstitial fluid, sweat, intraocular fluid, vitreous humor, cerebrospinal fluid, extracellular fluid, lacrimal fluid, saliva, mucus, etc., and any other bodily fluid.

The sample can be obtained from any useful source, such as a subject (e.g., a human or non-human animal), a plant (e.g., an exudate or plant tissue, for any useful testing, such as for genomic and/or pathogen testing), an environment (e.g., a soil, air, and/or water sample), a chemical material, a biological material, or a manufactured product (e.g., such as a food or drug product).

The present invention will be further understood by reference to the following non-limiting examples.

### EXAMPLES

### Example 1. System Design and Microfluidic Valve and Peristaltic Pump Operation

### Materials and Methods

System and circuitry design. Clinically useful PoC devices require seamless integration of biochemical assays, fluid handling and signal readout. The platform integrated a bead-based electronic ELISA biosensor, an amperometry readout circuitry and an automated microfluidic fluid management circuitry into one system (FIG. 1). Performing amperometry measurement and controlling microfluidic fluid management, the single-chip potentiostat (ADUCM350 from Analog Devices, Inc) is the heart of this all-electrical system (FIG. 1). Interfaced with two 8-bit shift registers, the microcontroller can control up to 16 solenoid valves. The use of shift registers allows for the operation of multiple solenoids simultaneously, which enables complex fluid management. For example, to realize peristaltic pumping, at least three solenoids are needed (Melin and Quake, Annual Review of Biophysics and Biomolecular Structure, 36:213-231 (2007)). The solenoids valves are connected to microfluidic valves and can be programmed to achieve fluid management such as peristaltic pumping, mixing and valving.

Through a 16-channel single-pole-single-throw analog multiplexer, the microcontroller can alternate amperometry measurement across up to 16 electrochemical cells. The biosensor is connected to the amperometry circuitry through a card edge connector.

Microfluidics-based electrochemical biosensor. A multiplexed bead-based electronic ELISA was developed (Wu et al., Biosensors & Bioelectronics, 117:522-529 (2018)) As illustrated in FIG. 2A, the assay consists of three steps. First, magnetic beads (DYNABEADS MYONE STREPTAVIDIN T1, Thermo Fisher Scientific) that are loaded with antibodies and enzymes (horseradish peroxidase) are mixed with samples to capture protein biomarkers. These beads are then sent to interact with electrodes coated with antibodies. In this step, the beads that capture protein molecules will attach to the electrode surface and remain after a washing step. During the readout stage, a substrate (mixture of 3,3′,5,5′-Tetramethylbenzidine and hydrogen peroxide) is introduced to generate current.

Here, a microfluidics-based electrochemical biosensor integrates antigen capture and bead detection together and automates the assay. The biosensor contains three electrodes (gold working electrode, gold counter 20 electrode and Ag/AgCl reference electrode) and a microfluidic channel. To improve assay throughput and provide multiplexed measurement, a device containing eight parallel sensors (FIG. 2B) was developed. Electrodes were fabricated by patterning 15 nm Ti and 200 nm Au on a Pyrex wafer through standard photolithography and lift-off techniques. The microfluidic channels consisted of two layers: control layer (at the top) and flow layer (at the bottom). Both channels had a rectangular cross-section and a height of 70 μm. The width of flow channel was 600 μm.

The microfluidics primarily consisted of an analyte capture zone (total volume of 1.07 μL) and a detection zone (total volume of 0.47 μL) (FIG. 2C), each of which featured a rotary mixer and microfluidic valves. Using the programmable fluid control module to actuate those valves, every step of the bead-based electronic ELISA was realized on this biosensor. The assay began with loading sample and magnetic beads. The rotary peristaltic pump drove solution to circulate in the analyte capture zone, mixing beads with samples and enhancing analyte binding onto beads. The beads were then moved into the detection zone by a flow and concentrated by a magnet. The rotary pump in the detection zone brought the beads into solution uniformly so that they could attach to the electrodes (Wu et al., Biosensors & Bioelectronics, 117:522-529 (2018)). Unbounds beads were washed away, followed by injection of substrate to generate current signals.

Microfluidic valves are the basis of this microfluidic automation. As shown in FIGS. 2D and 2E, valves were created at the intersection between control channels (which were pressurized) and flow channels (where samples and chemical reagents flowed). These two channels were separated by a thin PDMS membrane. When the control channels were pressurized, the membrane deformed and protruded into the flow channel, stopping the flow. A round flow channel is usually designed such that it can be fully closed (Unger et al, Science, 288:113-116 (2000)). However, in the push-down configuration, flow channels need to be shallow and a high pressure is required to close the valves. A tall rectangular flow channel was designed to accommodate sufficient sample. Even without full closure of microfluidic valves, partial closure was sufficient for this assay as demonstrated in results.

### Results

Since valves operation is important to assay automation, the operation of microfluidic valves with a round-cross-section flow channel was examined. Particularly, valve actuation to determine the optimal pressure parameters were investigated. Valve closure was estimated by dividing the width of closure area (lᵥ) by the width of flow channel (l_{c}). It was observed that valve closure increases as pressure rises. When the pressure is 10 psi, the valve closure is 72.16% (lᵥ=417.9 μm, l_{c}=573.3 μm). The valve closure increases to 87.70% when the pressure is 30 psi. While the valve can close up to 91.06% under a pressure of 40 psi, the valve operation pressure was chosen to be 30 psi, because it was found that pressure higher than that may cause the microfluidic device to leak. It is worth noting that due to the rectangular geometry of flow channels, the valves may not be fully closed, unlike the valves with round flow channels. However, the rectangular flow channels were sufficiently closed to achieve automated protein testing.

Peristaltic pumps can be built by actuating multiple valves in designated sequences. Valve sequencing was optimized to enable mixing beads with samples, and re-suspending beads (flowing beads concentrated by an external magnet) (FIGS. 2C-2E). Specific valve characteristics were investigated to refine the assay.

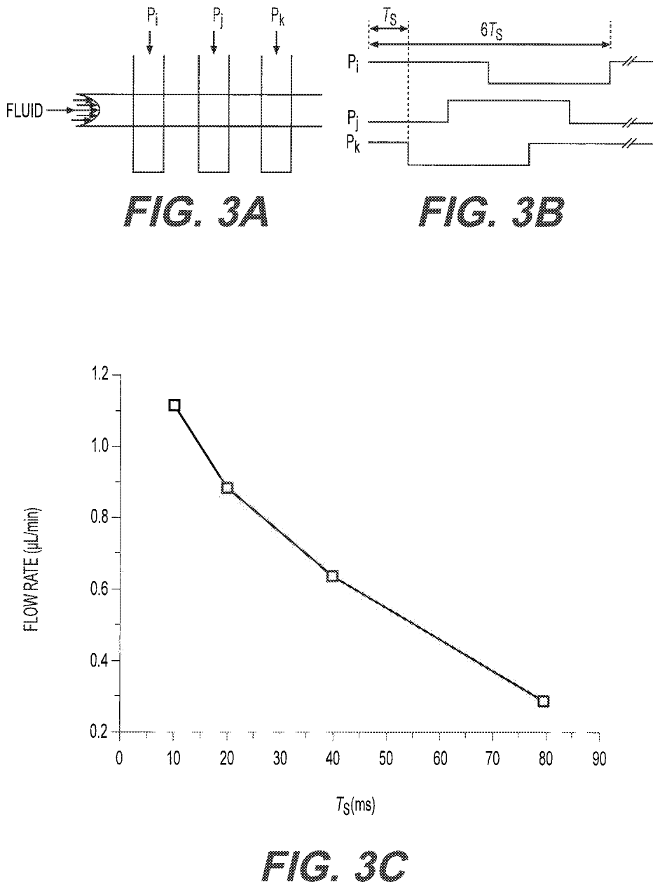

The three microfluidic valves in the antigen capture zone were modulated following a repeated sequence PiPjPk=101→100→110→010→011→001 (FIG. 3A). Each state in the sequence last for a duration of Tₛ. A snapshot of bead motion under flow driven by the peristaltic pump was taken, where Tₛ=10 ms. The bead trajectory indicated the presence of flow. From the bead trajectories, it was estimated that the maximum bead velocity was 773 μm is and thus the flow rate was 1.11 μL/min. The influence of sequence duration (i.e., Tₛ) on flow rate was examined (FIG. 3C). It is observed that flow rate increased as the sequence duration become shorter. While the solenoid control circuitry can change state very fast, the response time of solenoid valves can limit the speed of peristaltic pumping. The duration of Tₛ=10 ms was chosen, which is close to the response time of solenoids valves (3 Port Solenoid Valves S070 Series from SMC Corporation of America). These results also validated usage of valves with rectangular flow channels

### Example 2. Rotary Mixer Testing and IL-6 Detection with Electronic ELISA Biosensor.

### Materials and Methods

The microfluidic system was used to detect an analyte in a minimal sample volume.

The system detection electrodes were prepared as described (Wu et al., Biosensors & Bioelectronics, 117:522-529 (2018)).

Materials: All chemicals used were of analytical grade and used as received without any further purification. Potassium ferricyanide, 3,3′,5,5′-Tetramethylbenzidine tablets (TMB, 1 mg) and hydrogen peroxide (H₂O₂, 30%) were purchased from Sigma. 1-ethyl-3-(3-dimethylaminopropyl)carbodiimide hydrochloride (EDC), N-hydroxysulfosuccinimide (sulfo-NHS), Dulbecco's phosphate-buffered saline (PBS), CT(PEG)12 Carboxy-PEG-Thiol Compound [CT(PEG)12], 4-morpholinoethanesulfonic acid buffered saline packs (MES), bovine serum albumin blocking solution (BSA, 10%), biotinylated horseradish peroxidase (B-HRP) and streptavidin microbead (Dynabead, Myone, T1) were from ThermoFisher Scientific. Sulfo-NHS and EDC were dissolved in MES buffer (25 mM EDC, 25 mM sulfo-NHS) immediately before use. Human interleukin-6 (IL-6) DuoSet ELISA development kit and biotinylated human IL-6 antibody (Goat IgG, BAF206) were purchased from R&D Systems. While the DuoSet ELISA kit came with its own biotinylated human IL-6 antibody, the BAF-206 antibody was used instead for sandwich assays. Nano-Strip were from KMG Chemicals, Inc. Ag/AgCl ink for reference electrode was purchased from ALS Co., Ltd.

Method: During the surface modification of the electrochemical biosensors, the gold electrodes were cleaned in 60° C. Nanostrip for one hour, and then rinsed with deionized water (DI) to remove any residual Nanostrip. Ag/AgCl ink was applied onto the reference electrode and heated at 120° C. for two minutes to form Ag/AgCl reference electrodes. The electrodes were then immersed in 2 mM CT(PEG)12 overnight. After rinsed with DI water, the surface was activated by 25 mM NHS/25 mM EDC for 15 min, and rinsed with DI water. After that, 0.2 mg/ml capture antibody (BAF206) was added onto the activated electrodes and incubated for three hours, followed by washing with PBS and blocking with 3% BSA for three hours.

### Results

Rotary mixers were used to mix beads with sample, and re-suspend beads in the detection zone. Therefore, it is important to examine the performance of the rotary mixers. Experiments were conducted to investigate mixing of biomolecules and microbeads separately.

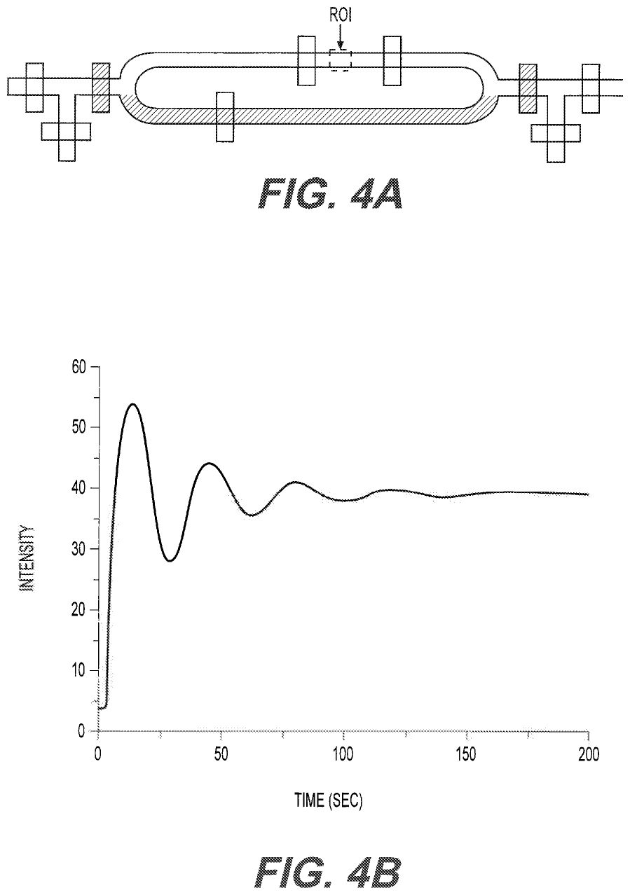

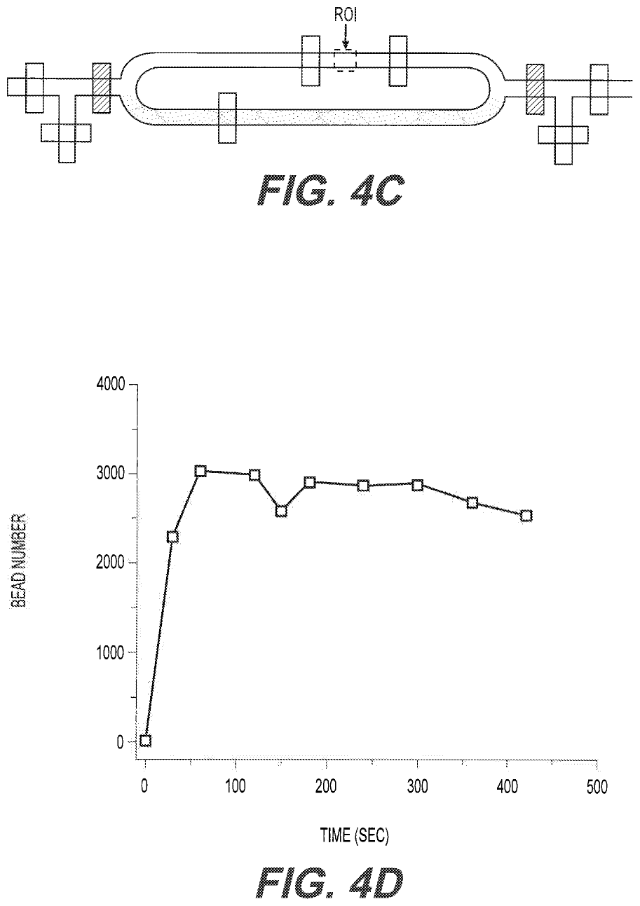

To study mixing of biomolecules, similarly as in an assay where only half of the rotary mixer is filled with sample, a solution of bovine serum albumin (BSA) conjugated to Alexa Fluor 488 dye was loaded into one half of the rotary while the other half was filled with buffer. As BSA has similar diffusion coefficient with many protein biomarkers, the experiment is representative of mixing in a bioassay. Then the rotary pump was started (with Tₛ=10 milliseconds) and observed the fluorescent intensity change over time (FIGS. 4A and 4B). It should be noted that because the solution has not been completely mixed in the beginning, the fluorescence intensity fluctuates with a period of 35 seconds which corresponds to fluid cycling time in the rotary. The intensity becomes flat after about 120 seconds, showing the BSA solution was well mixed.

A similar approach was used to examine mixing of micro-beads. Instead of measuring fluorescence intensity, bead number was counted over time and the results are shown in FIGS. 4C and 4D. After 60 seconds, the bead number does not change significantly. The mean value is 2809 and standard deviation is 188 (i.e., 6.7% of mean value), showing the beads are almost uniform in the channel.

From these measurements, it was concluded that it will take 1-2 minutes to mix the bead solution and the sample solution so that they are uniformly distributed in the rotary. This time is appropriate for the overall assay duration.

A 30-minute integrated and automated sensing of IL-6

Having validated the key components of the system, the system was used for an integrated and automated measurement of human IL-6 in human plasma.

As illustrated in FIG. 2C, the assay started with manually and sequentially loading magnetic beads and samples into the capture rotary. After that, the assay ran automatically until it concluded. Briefly, the peristaltic pump drove the flow to circulate in the rotary mixer, mixing beads with samples. The bead-sample incubation time was 15 minutes. The mixture of bead and sample was sent to the detection zone, which took 30 seconds. The beads were pulled down by a magnet controlled by a solenoid and the sample solution went to waste. The peristaltic pump in the detection zone started for 2 minutes and re-suspended the beads again into solution. After the pump stopped, the beads were allowed to interact with electrodes for 8 minutes. A two-minute washing step was then carried out to remove unbound beads. Finally, a substrate was introduced into detection zone for amperometry measurement, which took up to 3 minutes.

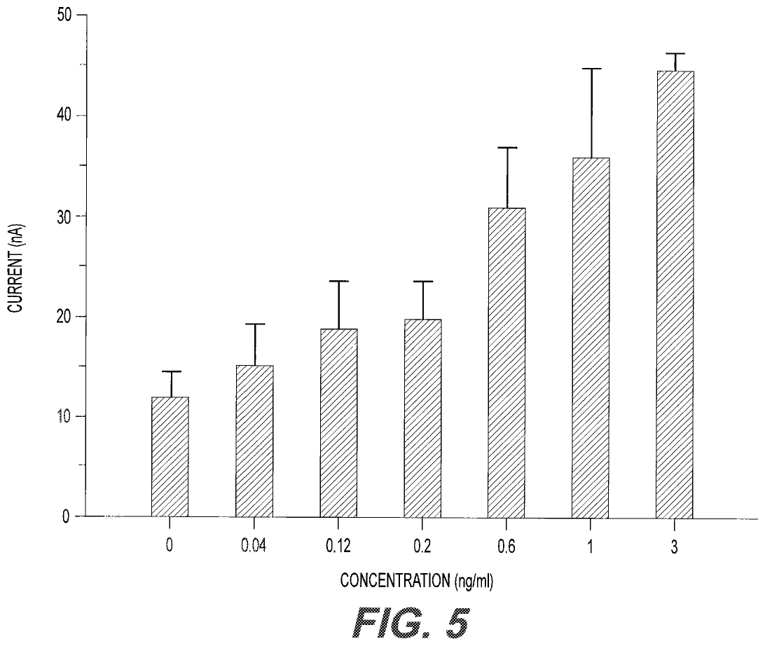

The results are presented in FIG. 5, which shows that the system measures IL-6 down to 0.04 ng/ml within 30 minutes. Additionally, due to the usage of the microfluidic system, the assay needs less than 1 μL sample. The all-electrical platform is suitable for PoC applications.

Therefore, an integrated and automated electronic system for PoC protein testing. Programmable fluidic control (e.g., microfluidic peristaltic pumping) was achieved by combining solenoid valves and microfluidic valves. Using human IL-6 as an example, the integrated platform was shown to be able to perform sensitive, rapid and automated protein assays.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1. A microfluidic chip comprising one or more electrochemical biosensors, each biosensor comprising:
a) a flow layer comprising
an analyte capture zone comprising a microfluidic rotary mixer; and
a detection zone comprising a microfluidic rotary mixer with a sensing region comprising a working electrode;
wherein the analyte capture zone is fluidically connected with the detection zone by a microfluidic channel; and
b) a control layer comprising one or more valves positioned above or below the flow layer and intersecting the analyte capture zone, the detection zone, or both,
wherein the rotary mixers are looped microfluidic channels intersected with at least one, at least two, or at least three valves.

2. The microfluidic chip of claim 1, wherein the one or more valves of the control layer comprise a flexible membrane at intersections with the analyte capture zone, the detection zone, or both.

3. The microfluidic chip of claim 1, wherein the one or more valves of the control layer form a rotary pump comprising at least three valves configured for sequential operability and intersecting the analyte capture zone and/or the detection zone.

4. The microfluidic chip of claim 3, wherein the rotary pump is a peristaltic pump.

5. The microfluidic chip of claim 1, comprising an inlet zone comprising one or more microfluidic channels fluidically connected to the analyte capture zone.

6. The microfluidic chip of claim 1, comprising a collection zone comprising one or more microfluidic channels fluidically connected to the detection zone.

7. The microfluidic chip of claim 1, wherein the control layer comprises one or more microfluidic valves intersecting any one of microfluidic channels fluidically connecting the inlet zone to the analyte capture zone, the analyte capture zone to the detection zone, and the detection zone to the collection zone.

8. The microfluidic chip of claim 1, wherein the control layer is below the flow layer and the valves are pushed up into the flow layer.

9. The microfluidic chip of claim 1, wherein the flow layer comprises microfluidic channels having a substantially circular cross-section.

10. The microfluidic chip of claim 1, wherein the flow layer comprises microfluidic channels having a substantially angular cross-section, wherein height to width ratio of the microfluidic channels is between about 1:2 and about 1:15.

11. The microfluidic chip of claim 1, wherein the flow layer comprises microfluidic channels having a diameter or a height between about 10 μm and 1000 μm, and length between about 5 and 100 mm.

12. The microfluidic chip of claim 1, wherein the microfluidic rotary mixer comprises a looped microfluidic channel having a geometry selected from the group consisting of a square, a rectangular, and a triangular cross-section.

13. The microfluidic chip of claim 1, wherein the detection zone comprises a trap region comprising a magnet, a gel, or a capture substance.

14. The microfluidic chip of claim 1, wherein the sensing region is coated with a capture moiety.

15. The microfluidic chip of claim 1, comprising between two and ten electrochemical biosensors.

16. A device comprising the microfluidic chip of claim 1.

17. The device of claim 16, comprising a microfluidic controlling module and a display means.

18. The device of claim 17, wherein the microfluidic controlling module comprises a solenoid valve array.

19. A method of making the microfluidic chip of claim 1 or a device comprising the microfluidic chip comprising forming the flow layer and/or the control layer using one or more methods selected from the group consisting of stereolithography, soft lithography, laser machining, micromachining, curing, bonding, three-dimensional printing, molding, micromolding, thermal setting, metal deposition, and coating.

20. A method of measuring analyte concentration in a sample comprising applying the sample and an analyte capture element to the flow layer of the microfluidic chip of claim 1, or to a device comprising the microfluidic chip.

21. The method of claim 20, comprising mixing the sample and the analyte capture element in the microfluidic rotary mixer of the analyte capture zone to obtain captured analyte.

22. The method of claim 20, comprising trapping the captured analyte in a trap region of the detection zone.

23. The method of claim 22, comprising trapping the captured analyte in a trap region of the detection zone and washing with buffer.

24. The method of claim 21, comprising flowing the captured analyte over the sensing region to contact the one or more electrodes of the sensing region.

25. The method of claim 20, comprising adding a substrate reagent and recording a change in current from the sensing region.

26. The method of claim 20, wherein any one of mixing, trapping, washing, and flowing is accomplished using one or more peristaltic pumps.

27. The method of claim 20, comprising detecting a concentration of the analyte in the sample based on a change in current from the sensing region.

28. The method of claim 20, wherein the microfluidic chip operates with sample volumes between about 0.5 μm and 500 μL.

29. The method of claim 20, wherein the microfluidic chip operates at flow rates between about 0.5 μL/min and 15 μL/min.

30. The method of claim 20, wherein the valves in the microfluidic chip operate at pressures between about 5 psi and 50 psi.

31. The method of claim 20, wherein the microfluidic chip operates at valve closure between about 50% and 95%.

32. The method of claim 20, wherein the microfluidic chip comprises between two and ten electrochemical biosensors and is configured to measure the concentration of the same analyte with the biosensors, or the concentrations two to ten different analytes with biosensors.
